(19) United States
(12) Patent Application Publication
(10) Pub. No.: US 2008/0109859 A1
(43) Pub. Date: May 8, 2008

(54) Video on demand system for providing graceful degradation and fault tolerance and method thereof

(75) Inventors: Pong-Sheng Wang, Taipei City (TW); Chie-Jin Cheng, Taipei City (TW); Ching-San Hsu, Taipei City (TW)

Correspondence Address: BACON & THOMAS, PLLC, 625 SLATERS LANE, FOURTH FLOOR, ALEXANDRIA, VA, 22314, US

(73) Assignee: NSTREAMS TECHNOLOGIES, INC., TAIPEI (TW)

(21) Appl. No.: 11/593,531

(22) Filed: Nov. 7, 2006

(51) Int. Cl. H04N 7/173

(52) U.S. Cl. 725/87

(57) ABSTRACT

A video on demand system for providing graceful degradation and fault tolerance comprises a plurality of media storage ends, a first level network device, and a plurality of video trunk combiners. Each of the media storage ends respectively stores a plurality of video files, and provides a plurality of frequency channels to transmit the video files. The first level network device receives each of the frequency channels provided by each of the media storage ends, and externally transmits at least one of the frequency channels provided by at least two of the media storage ends. Each of the video trunk combiners is connected between the first level network device and at least one user end, and receives the at least one of the frequency channels provided by at least two of the media storage ends via the first level network device.

### FIELD OF THE INVENTION

The present invention relates to a video on demand (VOD) system and method, and more particularly to a video on demand (VOD) system for providing graceful degradation and fault tolerance and method.

BACKGROUND OF THE INVENTION

Nowadays, most video is broadcast or stored by using various storage media, such as optical disks (i.e. CD, VCD, LD, and etc), video tapes, cable television (CATV), radio television, and etc., wherein the optical disks (i.e. CD, VCD, and LD) and the video tapes are mechanical systems, and cable television and the radio television are electronic transmission systems. Thus, cable television and the radio television can be selected to transmit video programs in consideration of saving transmission time and enhancing transmission efficiency. However, if using optical disks (i.e. CD, VCD, and LD) or videotapes for playing video, a user can actively control various play functions, such as stop, reverse, forward, shuttle, fast, slow, etc. On the contrary, cable television or radio television only allowing viewing, the user cannot interactively control video via the previously listed play functions, except for selecting the video channel. As a result, there is no interaction between the user and cable television or radio television during play. While there is a relatively high-level of interaction between the user and optical disks (i.e. CD, VCD, and LD) or the videotapes based on its higher active controllability.

As described above, manufacturers are actively developing a kind of video selection system, called video on demand (VOD), in which video programs can be optionally selected by a user, i.e. the user can actively select any desired video program while controlling the play mode of the desired video program. Thus, the VOD system can be used to solve the problems of playing conventional video programs, such as relatively low interaction during operation, time limitations, controllability, limitation of transmission space, and relatively lower selection of operation. In other words, when the VOD system is used to play video programs, the user can actively and comprehensively control the play modes of the video programs to decide the progress of a favorite video. The VOD system uses an electronic high-speed transmission mode for transmitting video programs so that the VOD system can save more transmission time and enhance transmission efficiency while the user can actively control the video programs during playing.

Referring now to FIG. 1, a conventional VOD system comprises a media storage end 10, a plurality of user ends 12 apart from the media storage end 10, and a transmission network 14 suitably interconnected between the media storage end 10 and the user ends 12. The media storage end 10 is mainly used to store video files, play the video files, manage the user data, calculate the video charges, and monitor the Internet. Transmission network 14 is used to transmit video files from the media storage end 10 to the user ends 12. The user ends 12 are generally provided with corresponding terminal appliances for receiving video files transmitted from the media storage end 10. For example, when the VOD system is applied to a CATV system, it is necessary to mount a television and a set top box (STB) on each of the user ends 12. In another aspect, when the VOD system is applied to an Internet system, it is necessary to provide a computer or a server as the terminal appliances of the user ends 12.

Furthermore, the media storage end 10 is connected to the transmission network 14 via at least one transmission medium, such as coaxial cable, while each of the user ends 12 is connected to the transmission network 14 via a transmission medium, such as coaxial cable. Suppose that each of the transmission media has a bandwidth of about 800 MHz, and each channel has a bandwidth about 8 MHz, each transmission media, such as coaxial cable, will be able to transmit and provide 100 different frequency channels, i.e. the maximum transmission capability of the media storage end 10 is to simultaneously provide 100 different frequency channels to the user end 12 via the transmission network 14.

However, because only one transmission medium is connected between the media storage end 10 and the transmission network 14, and also only one transmission medium is connected between the transmission network 14 and the user end 12, the media storage end 10 may not be used to provide the frequency channels to the user end 12 via the transmission network 14 once either the media storage end 10, the transmission network 14, and any transmission media malfunctions. In other words, due to the user ends 12 receiving video files via the transmission network 14, problems arise from inconvenient operation at the user ends 12.

It is therefore tried by the inventor to develop a video on demand (VOD) system for providing graceful degradation and fault tolerance and method thereof to solve the problems existing in the conventional video on demand (VOD) system.

### SUMMARY OF THE INVENTION

A primary object of the present invention is to provide a video on demand (VOD) system for providing graceful degradation and fault tolerance, which comprises at least one first level network device, a plurality of media storage ends, and a plurality of video trunk combiners, wherein each of the media storage ends is used to provide a plurality of frequency channels, one portion of the frequency channels respectively provided by each of the media storage ends is transmitted to a common video trunk combiner via the first level network device, when one of the media storage ends malfunctions or is being repaired, the video trunk combiners lose the portion of the frequency channels, in other words, the amount of frequency channels provided by the video trunk combiners decreases, but the video trunk combiners still can provide the frequency channels provided by the other of the media storage ends for each user end connected to the video trunk combiners, i.e. the VOD system of the present invention can efficiently provide graceful degradation and fault tolerance.

A secondary object of the present invention is to provide a method for providing graceful degradation and fault tolerance in a video on demand (VOD) system which comprises at least one first level network device, a plurality of media storage ends, and a plurality of video trunk combiners, wherein each of the media storage ends is used to provide a plurality of frequency channels which are respectively transmitted to the corresponding video trunk combiners via the first level network device, when one of the media storage ends malfunctions or is being repaired, only the number of frequency channels provided by the video trunk combiners for each user end connected to the video trunk combiners decreases, but the user ends still can receive video files transmitted from the media storage ends, i.e. the VOD system of the present invention can efficiently provide graceful degradation and fault tolerance.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a block diagram of a conventional video on demand (VOD) system;

FIG. 2 is a block diagram of a video on demand (VOD) system for providing graceful degradation and fault tolerance according to a first preferred embodiment of the present invention;

FIG. 3 is a block diagram of a video on demand (VOD) system for providing graceful degradation and fault tolerance according to a second preferred embodiment of the present invention;

FIG. 4 is a block diagram of a video on demand (VOD) system for providing graceful degradation and fault tolerance according to a third preferred embodiment of the present invention;

FIG. 5 is a 6×6 matrix diagram of 36 frequency channels according to the third preferred embodiment of the present invention;

FIG. 6 is a matrix diagram of frequency channels having a plurality of numerals corresponding to each media storage end according to the third preferred embodiment of the present invention, similar to FIG. 5;

FIG. 7 is a matrix diagram of frequency channels having a plurality of numerals received by each second level network device according to the third preferred embodiment of the present invention, similar to FIG. 5;

FIG. 8 is a matrix diagram of frequency channels having a plurality of numerals received by each of video trunk combiners according to the third preferred embodiment of the present invention, similar to FIG. 5; and

FIG. 9 is a block diagram showing numerals of the frequency channels respectively corresponding to the media storage ends, the second level network devices, and the video trunk combiners according to the third preferred embodiment of the present invention, as illustrated in FIG. 4 and 6.

### DETAILED DESCRIPTION OF THE PREFERRED EMBODIMENTS

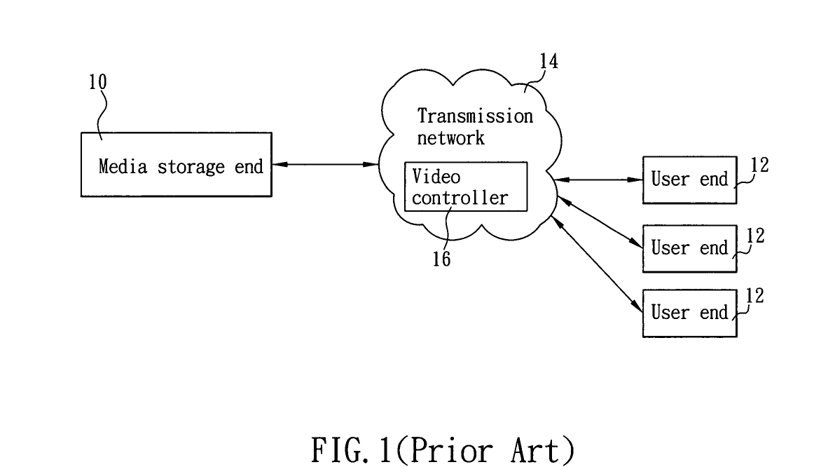

Traditionally, a simplified video on demand (VOD) system comprises at least one media storage end 10, such as a video server, at least one user end 12, and a transmission network 14. As shown in FIG. 1, the media storage end 10 of the prior art is connected to the transmission network 14 via at least one transmission medium, such as coaxial cable, while the user end 12 is connected to the transmission network 14 via at least one corresponding transmission medium, such as coaxial cable, wherein each of the media storage end 10 stores each video file using a redundant array of independent disks (RAID), and the media storage end 10 is connected to at least one video controller 16 of the transmission network 14. Furthermore, the user end 12 can enter a transmission path of the transmission network 14 via the video controller 16 to transmit a video file of the media storage end 10 from the transmission network 14 to one of the user ends 12. Thus, if the media storage end 10, the transmission network 14, or any one of transmission media in the VOD system malfunctions, the user end 12 will not receive any video file. In other words, any internal fault of the transmission network 14, or any external fault of the transmission media connected between the media storage end 10 and the user end 12 may prevent the media storage end 10 from providing any video file to any user end 12 via the transmission network 14.

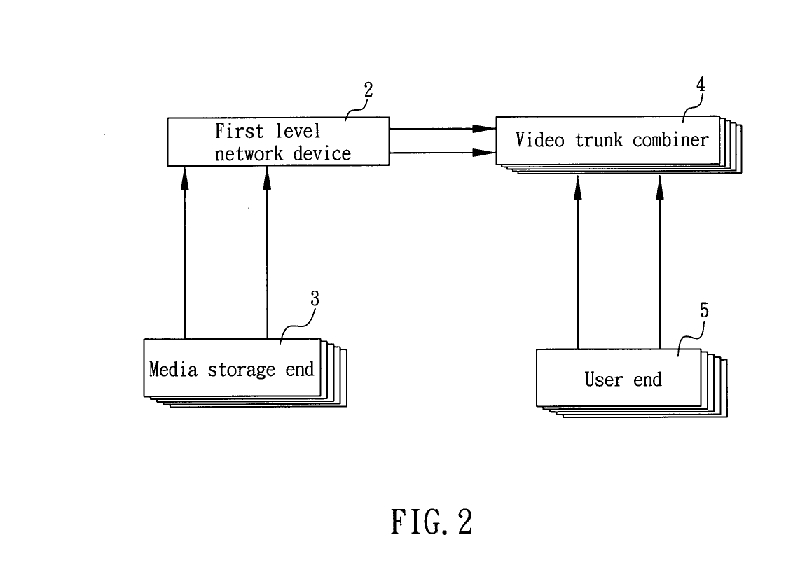

Referring to FIG. 2, a first preferred embodiment of the present invention provides a video on demand (VOD) system for efficiently providing graceful degradation and fault tolerance to solve the problems as described above. As shown, the VOD system comprises a first level network device 2 (such as switch), a plurality of media storage ends 3 (such as video server) which is connected to one end of the first level network device 2, a plurality of video trunk combiners 4 connected to the other end of the first level network device 2, and a plurality of user ends 5 connected to the video trunk combiners 4, wherein at least one frequency channel respectively is provided by at least two media storage ends 3 and is transmitted to one of the video trunk combiners 4 via the first level network device 2.

Referring still to FIG. 2, in other words, the video trunk combiners 4 receive one portion of all of the frequency channels respectively provided by each of the media storage ends 3 via the first level network device 2 so that each of the user ends 5 can receive the frequency channels respectively provided by each of the media storage ends 3 from one of the video trunk combiners 4 correspondingly connected to the user ends 5. Furthermore, when one of the media storage ends 3 malfunctions or is being repaired, only the amount of the frequency channels transmitted by the video trunk combiners 4 slightly decreases, i.e. even though the frequency channels provided by the malfunctioned or repaired media storage ends 3 cannot be received, the user ends 5 still can receive the frequency channels provided by the remaining media storage ends 3 via the video trunk combiners 4, so that the VOD system of the present invention can efficiently provide graceful degradation and fault tolerance.

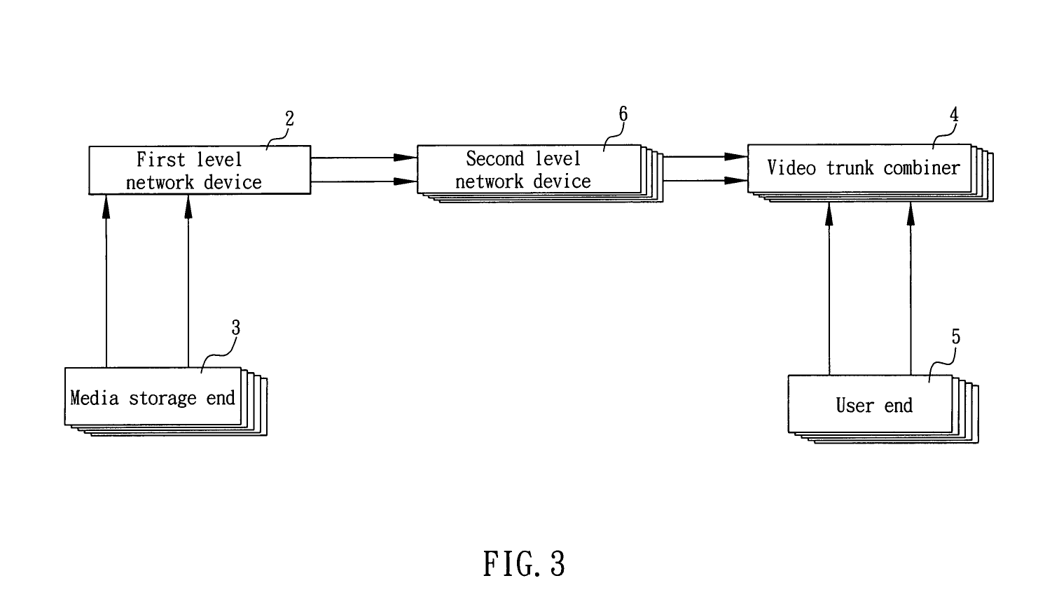

Referring now to FIG. 3, a video on demand (VOD) system for providing graceful degradation and fault tolerance according to a second preferred embodiment of the present invention is illustrated. As shown, in comparison with the first preferred embodiment, the VOD system further comprises a second level network device 6, such as quadrature amplitude modulation gateway (QAM gateway), which is between the first level network device 2 and the video trunk combiners 4. At least one frequency channel is provided by at least two of the media storage ends 3 via the first level network device 2 will be transmitted to the second level network device 6. Then, at least one frequency channel is provided by at least two of the media storage ends 3 via the second level network device 6 will be further transmitted to the video trunk combiners 4 so that the video trunk combiners 4 will receive each of the frequency channels provided by each of the media storage ends 3. As a result, all of the frequency channels provided by the media storage ends 3 will be transmitted to the video trunk combiners 4 via the first and second level network devices 2,6 so as to efficiently provide enhanced graceful degradation and fault tolerance.

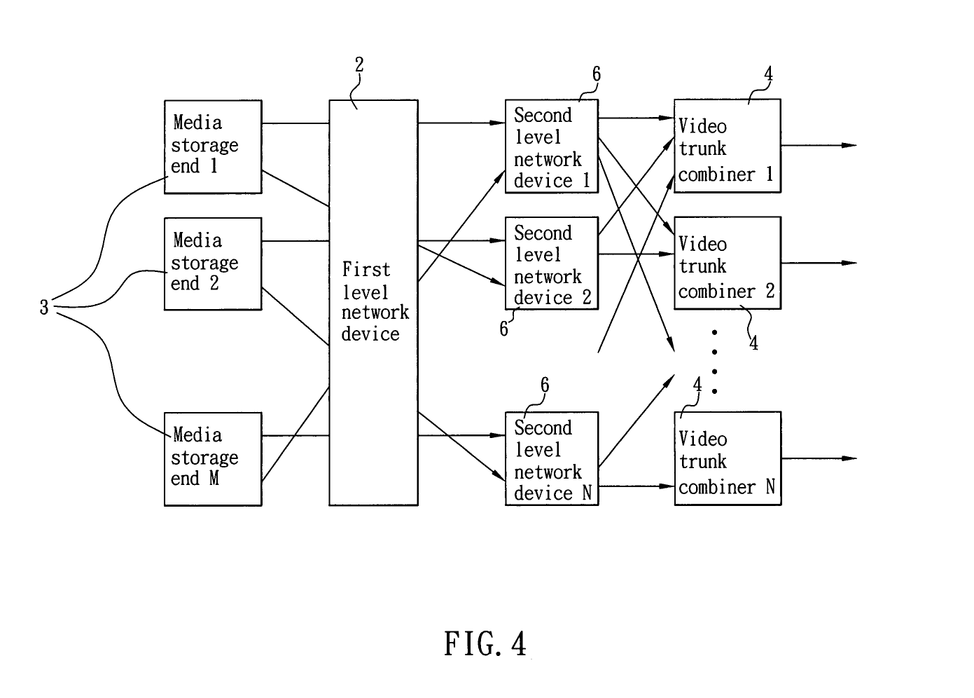

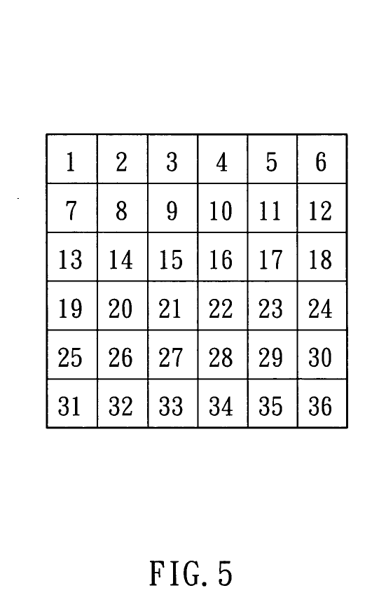

Referring now to FIG. 4 and 5, a video on demand (VOD) system for providing graceful degradation and fault tolerance according to a third preferred embodiment of the present invention is illustrated to describe the present invention more detailed hereinafter. As shown, suppose that the VOD system comprises three media storage ends 3, a first level network device 2, three second level network device 6, and six video trunk combiners 4, while the three media storage ends 3 of the VOD system are used to provide 36 frequency channels. In the third preferred embodiment, in order to conveniently transmit each of the frequency channels to each of the second level network device 6 and the video trunk combiners 4 via the first level network device 2, the frequency channels are arranged in a 6×6 numeral matrix as shown in FIG. 5.

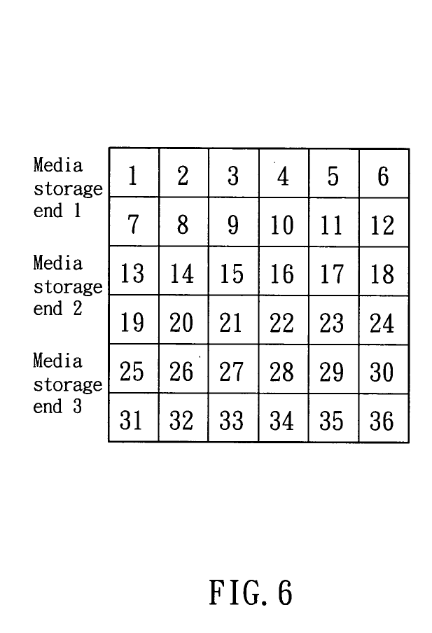

Referring now to FIG. 6, another numeral matrix is illustrated to describe the numeral matrix of FIG. 5 more detailed hereinafter. As shown, a first one of the media storage ends 3 is used to provide twelve frequency channels designated by numerals 1 to 12 in two upper rows of the numeral matrix; second of media storage ends 3 is used to provide another twelve frequency channels designated by numeral 13 to 24 located in two intermediate rows of the numeral matrix; and the third of media storage ends 3 is used to provide a further twelve frequency channels designated by numeral 25 to 36 located in the two lower rows of the numeral matrix.

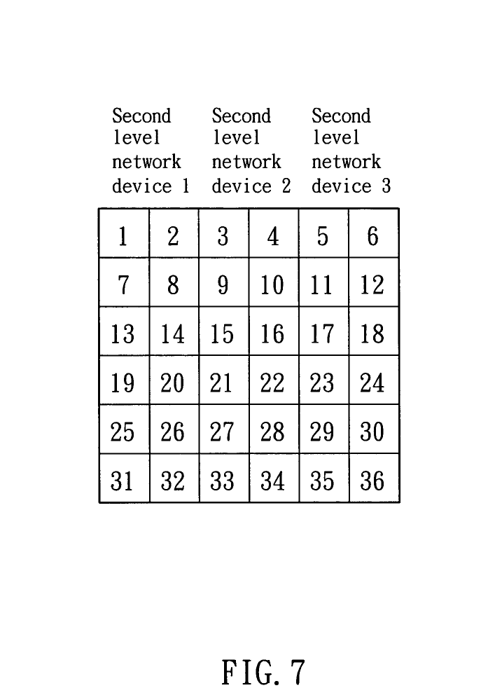

Referring now to FIG. 7, further another numeral matrix is illustrated to describe the numeral matrix of FIG. 5 and 6 more detailed hereinafter. As shown, the frequency channels provided via the first level network device 2 are separated into three groups in the numeral matrix, each of which includes two columns of the numeral matrix in turn and is respectively corresponding to a first one, a second, and a third one of the second level network device 6 from a left side of the numeral matrix to a right side thereof.

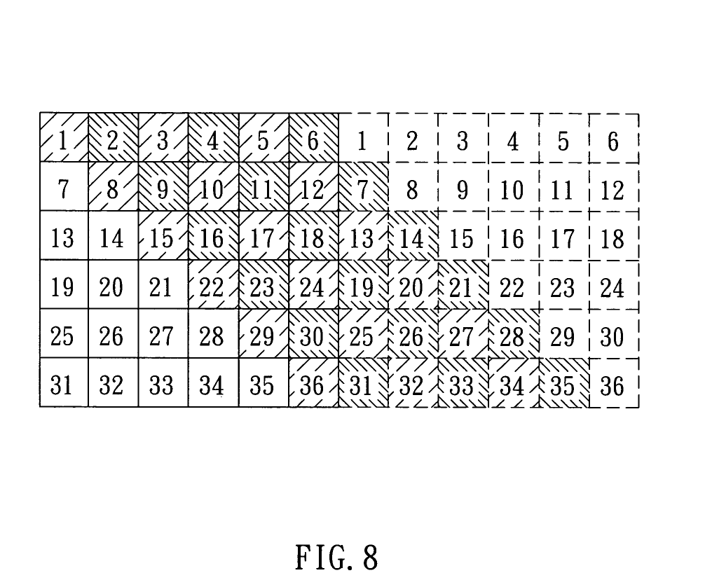

Referring now to FIG. 8, still further another numeral matrix is illustrated to describe the numeral matrix of FIG. 5, 6, and 7 more detailed hereinafter. As shown, the first, second, and third of the second level network devices 6 respectively transmit the corresponding portion of the frequency channels to one of video trunk combiners 4, wherein each portion of the frequency channels includes several numerals between a diagonal range from a left upper corner of the numeral matrix to a right lower corner thereof, such as numerals 1, 8, 15, 22, 29, and 36 corresponding to the first of the video trunk combiners 4. Meanwhile, another portion of the frequency channels which includes several numerals adjacent to the diagonal range along the same diagonal direction are transmitted to another one of the video trunk combiners 4 in turn, such as numerals 2, 9, 16, 23, 30, and 31 corresponding to a second one of the video trunk combiners 4, and etc. As shown in FIG. 8, it should be noted that a right half portion of FIG. 8 is a virtual numeral matrix in relation to a left half portion of FIG. 8 similar to the numeral matrix of FIG. 5.

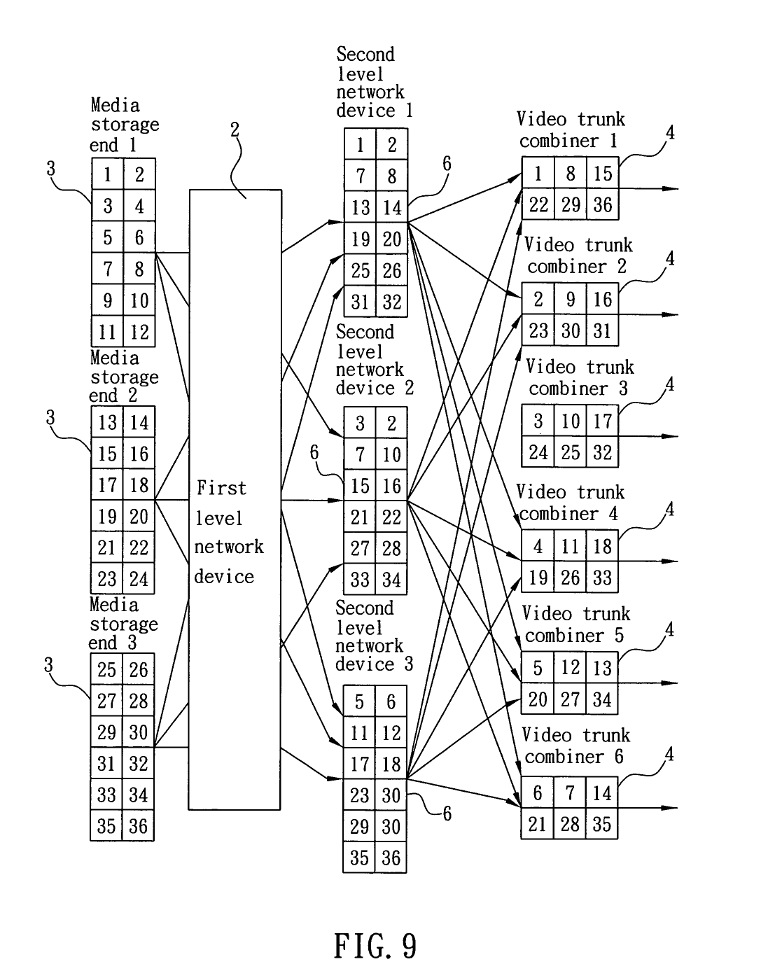

Referring now to FIG. 9, numerals of the frequency channels respectively corresponding to the media storage ends 3, the second level network devices 6, and the video trunk combiners 4 are illustrated. According to the transmission mode as described above, the VOD system of the present invention transmits each of the frequency channels to each of the second level network device 6 and each of the video trunk combiners 4 in turn, wherein each of the second level network devices 6 receives four of the frequency channels provided by each of the media storage ends 3 via the first level network device 2 while each of the video trunk combiners 4 receives two of the frequency channels provided by each of the media storage ends 3 via the second level network devices 6.

It should be noted that each of the second level network devices 6 and each of the video trunk combiners 4 are not limited to receiving frequency channels by the transmission mode as described above. According to the transmission mode, numerals of the frequency channels provided by the VOD system of the present invention can be arranged into a square numeral matrix, and substantially transmitted and distributed to each of the second level network devices 6 and each of the video trunk combiners 4 so that the present invention will be able to provide a preferred dispersion method with most balance. However, if numerals of the frequency channels provided by the VOD system are not enough to fully fill all spaces of a square numeral matrix, the numerals of the frequency channels still can be transmitted and distributed to each of the second level network devices 6 and each of the video trunk combiners 4 according to the same transmission mode even though numerals of the frequency channels corresponding to each of the second level network devices 6 and each of the video trunk combiners 4 may be not in a best dispersion condition with most balance at all.

Moreover, according to the present invention, each of the second level network devices 6 and each of the video trunk combiners 4 can respectively receive equal or different amounts of frequency channels. Even if any one of media storage ends 3 malfunctions, the user ends 5 still can receive the frequency channels provided by the other media storage ends 3 via the first level network devices 2, the second level network devices 6, and the video trunk combiners 4, i.e. this transmission mode is also a characteristic of the present invention.

In another aspect, the present invention provides a method for providing graceful degradation and fault tolerance in a video on demand (VOD) system which is used to provide a plurality of frequency channels arranged in a numeral matrix, wherein the frequency channels are transmitted and distributed to at least one of the media storage ends 3, at least one first level network device 2, a plurality of second level network devices 6, and a plurality of video trunk combiners in turn by the following steps of:
distributing at least one corresponding row of the frequency channels in the numeral matrix to each of the media storage ends 3, as shown in FIG. 6;
distributing at least one corresponding column of the frequency channels in the numeral matrix to each of the second level network device 6 via the first level network device 2, as shown in FIG. 7; and
distributing one portion of the frequency channels between a diagonal range of the numeral matrix to one of the video trunk combiners 4 via the second level network devices 6, while distributing another portions of the frequency channels adjacent to the diagonal range along the same diagonal direction to the other one of the video trunk combiners 4 in turn, as shown in FIG. 8;

Thereby, according the distribution mode of the VOD system of the present invention, each of the media storage ends 3 is used to provide one portion of the frequency channels which is respectively transmitted to the corresponding second level network device 6 via the first level network device 2, so that each of the second level network device 6 respectively receives the portion of the frequency channels provided by each of the media storage ends 3, and then the video trunk combiners 4 respectively receives the portion of the frequency channels provided by each of the media storage ends 3 via each of the second level network device 6, i.e. the VOD system of the present invention can efficiently provide graceful degradation and fault tolerance.

The present invention has been described with a preferred embodiment thereof and it is understood that many changes and modifications in the described embodiment can be carried out without departing from the scope and the spirit of the invention that is only limited by the appended claims.

What is claimed is:

1. A video on demand system for providing graceful degradation and fault tolerance, comprising:
a plurality of media storage ends respectively storing a plurality of video files and providing a plurality of frequency channels to transmit the video files;
a first level network device receiving each of the frequency channels provided by each of the media storage ends, and externally transmitting at least one of the frequency channels provided by at least two of the media storage ends; and
a plurality of video trunk combiners connected between the first level network device and at least one user end, each of the video trunk combiners receiving the at least one of the frequency channels provided by the at least two of the media storage ends via the first level network device.

2. The video on demand system for providing graceful degradation and fault tolerance of claim 1, wherein said first level network device is a switch.

3. The video on demand system for providing graceful degradation and fault tolerance of claim 1, wherein each of said media storage ends is a video server.

4. A video on demand system for providing graceful degradation and fault tolerance, comprising:
a plurality of media storage ends respectively storing a plurality of video files and providing a plurality of frequency channels to transmit the video files;
at least one first level network device receiving each of the frequency channels provided by each of the media storage ends, and externally transmitting at least one of the frequency channels provided by at least two of the media storage ends;
at least one second level network device respectively connected to at least two of the first level network device, each of the second level network device respectively receiving the at least one of the frequency channels provided by the at least two of the media storage ends via the first level network device connected to each of the second level network device; and
a plurality of video trunk combiners connected between at least two of the second level network device and at least one user end, each of the video trunk combiners receiving the at least one of the frequency channels provided by the at least two of the media storage ends via the second level network device connected to each of the video trunk combiners.

5. The video on demand system for providing graceful degradation and fault tolerance of claim 4, wherein each of said first level network device is a switch.

6. The video on demand system for providing graceful degradation and fault tolerance of claim 4, wherein each of said media storage ends is a video server.

7. The video on demand system for providing graceful degradation and fault tolerance of claim 4, wherein each of said second level network device is a quadrature amplitude modulation gateway.

8. A method for providing graceful degradation and fault tolerance in a video on demand system which provides a plurality of frequency channels arranged in a numeral matrix, wherein the frequency channels are transmitted to at least one of the media storage ends, at least one first level network device, a plurality of second level network devices, and a plurality of video trunk combiners in turn by the steps of:
distributing at least one corresponding row of the frequency channels in the numeral matrix to each of the media storage ends;
distributing at least one corresponding column of the frequency channels in the numeral matrix to each of the second level network device via the first level network device; and
distributing one portion of the frequency channels between a diagonal range of the numeral matrix to one of the video trunk combiners via the second level network devices, while distributing another portion of frequency channels adjacent to the diagonal range along the same diagonal direction to another one of the video trunk combiners in turn.
